(19) United States
(12) Patent Application Publication
(10) Pub. No.: US 2021/0071392 A1
(43) Pub. Date: Mar. 11, 2021

(54) CONSTRUCTION MACHINE

(71) Applicant: HITACHI CONSTRUCTION MACHINERY CO., LTD., Tokyo (JP)

(72) Inventors: Hidekazu MORIKI, Mito-shi (JP); Takaaki CHIBA, Kasumigaura-shi (JP); Shinya IMURA, Toride-shi (JP)

(21) Appl. No.: 16/961,006

(22) PCT Filed: Jan. 10, 2019
(86) PCT No.: PCT/JP2019/000603

§ 371 Date: Jul. 9, 2020

(30) Foreign Application Priority Data
Jan. 11, 2018 (JP) 2018-002651

(51) Int. Cl. E02F 9/22; F15B 19/00

(52) U.S. Cl. CPC E02F 9/2228; E02F 9/2267; E02F 3/32; F15B 19/007; E02F 9/2275

(57) ABSTRACT

An object of the present invention is to provide a construction machine that allows easy and accurate calibration of a pressure sensor and enables accurate control of hydraulic actuators. A controller increases the delivery pressure of a hydraulic pump in a state in which first and second meter-out valves and a second meter-in valve are closed and in which a first meter-in valve is opened, and calibrates a first pressure-calculation map such that a pressure calculated on the basis of the first pressure-calculation map matches a pressure calculated on the basis of a supply-pressure-calculation map, and increases the delivery pressure of the hydraulic pump in a state in which the first and second meter-out valves and the first meter-in valve are closed and in which the second meter-in valve is opened, and calibrates a second pressure-calculation map such that a pressure calculated on the basis of the second pressure-calculation map matches the pressure calculated on the basis of the supply-pressure-calculation map.

### TECHNICAL FIELD

The present invention relates to construction machines such as hydraulic excavators.

### BACKGROUND ART

In construction machines (e.g. hydraulic excavators), a hydraulic fluid delivered from a hydraulic pump is caused to flow into a first oil chamber of a hydraulic actuator (meter-in), and then discharged from a second oil chamber of the hydraulic actuator to a tank (meter-out), to thereby operate the hydraulic actuator. The flow rate of the hydraulic fluid flowing into the first oil chamber of the hydraulic actuator is adjusted by a meter-in valve, for example, and the flow rate of the hydraulic fluid discharged from the second oil chamber of the hydraulic actuator to the tank is adjusted by a meter-out valve, for example. The valve bodies of these valves move in accordance with lever operation of an operator. The flow rate passing through a valve is typically determined by the movement amount of the valve body (the opening area of the valve), and the pressure difference across the valve. Accordingly, the flow rate of the hydraulic fluid supplied to and discharged from the hydraulic actuator, that is, the operation velocity of the hydraulic actuator, changes in accordance with lever operation by the operator.

For example, Patent Document 1 intends to provide a simple method of accurately controlling a used section (hydraulic actuator), and discloses a fluid pressure valve configuration including: differential pressure sensors (pressure sensors) for sensing the pressure differences across a first valve configuration (meter-in valve) and a second valve configuration (meter-out valve); and opening sensors (position sensors) for sensing the openings (the opening areas or the movement amounts of the valve bodies) of the first valve configuration and the second valve configuration. In the fluid pressure valve configuration of Patent Document 1, the flow rate passing through the meter-in valve or the meter-out valve is controlled in accordance with the pressure difference across the meter-in valve or the meter-out valve calculated based on a signal from a corresponding one of the pressure sensors, and with the opening of the meter-in valve or the meter-out valve calculated based on a signal from a corresponding one of the opening sensors.

### PRIOR ART DOCUMENT

### Patent Document

Patent Document 1: JP-2005-98504-A

### SUMMARY OF THE INVENTION

### Problems to be Solved by the Invention

However, errors of the pressure sensors or the position sensors are not taken into consideration in the fluid pressure valve configuration described in Patent Document 1. That is, in a case where a pressure sensor error occurs, the pressure difference across a valve calculated based on a signal output from the pressure sensor also includes an error. In addition, in a case where a position sensor error occurs, the opening area calculated based on a signal output from the position sensor also includes an error. Accordingly, there is a fear that the flow rate passing through the meter-in valve or the meter-out valve, that is, the operation velocity of the hydraulic actuator, may not be controlled accurately, and therefore, there is a demand for technology that allows easy and accurate calibration of a pressure sensor or a position sensor to improve the sensing precision.

The present invention has been made in view of the problems described above, and an object of the present invention is to provide a construction machine that allows easy and accurate calibration of a pressure sensor or a position sensor and enables accurate control of hydraulic actuators.

### Means for Solving the Problems

In order to achieve the object described above, the present invention provides a construction machine including: a hydraulic pump; a supply hydraulic line connected to the hydraulic pump; a tank; a discharge hydraulic line connected to the tank; a hydraulic actuator having a first oil chamber and a second oil chamber; a first-actuator hydraulic line connected to the first oil chamber; a second-actuator hydraulic line connected to the second oil chamber; a first meter-in valve provided on a first connection hydraulic line connecting the supply hydraulic line and the first-actuator hydraulic line; a second meter-in valve provided on a second connection hydraulic line connecting the supply hydraulic line and the second-actuator hydraulic line; a first meter-out valve provided on a third connection hydraulic line connecting the first-actuator hydraulic line and the discharge hydraulic line; a second meter-out valve provided on a fourth connection hydraulic line connecting the second-actuator hydraulic line and the discharge hydraulic line; a bleed-off valve provided on a fifth connection hydraulic line connecting the supply hydraulic line and the discharge hydraulic line; a supply-pressure sensor that senses a delivery pressure of the hydraulic pump; a first-load-pressure sensor that senses a pressure of the first oil chamber; a second-load-pressure sensor that senses a pressure of the second oil chamber; and a controller that controls the first and second meter-in valves, the first and second meter-out valves, and the bleed-off valve in accordance with sensing signals of the first and second-load-pressure sensors, and a sensing signal of the supply-pressure sensor. The controller calculates the delivery pressure of the hydraulic pump from the sensing signal of the supply-pressure sensor on a basis of a supply-pressure-calculation map representing a characteristic of the supply-pressure sensor, calculates the pressure of the first oil chamber from the sensing signal of the first-load-pressure sensor on a basis of a first pressure-calculation map representing a characteristic of the first-load-pressure sensor, and calculates the pressure of the second oil chamber from the sensing signal of the second-load-pressure sensor on a basis of a second pressure-calculation map representing a characteristic of the second-load-pressure sensor. The controller increases the delivery pressure of the hydraulic pump in a state in which the first and second meter-out valves and the second meter-in valve are closed and in which the first meter-in valve is opened, and calibrates the first pressure-calculation map such that the pressure calculated on the basis of the first pressure-calculation map matches the pressure calculated on the basis of the supply-pressure-calculation map, and increases the delivery pressure of the hydraulic pump in a state in which the first and second meter-out valves and the first meter-in valve are closed and in which the second meter-in valve is opened, and calibrates the second pressure-calculation map such that the pressure calculated on the basis of the second pressure-calculation map matches the pressure calculated at the supply-pressure calculating section.

According to the thus-configured present invention, by reducing the rate of flow passing through the first or second meter-in valve by actuating the first or second meter-in valve in a state in which the first and second meter-out valves are closed, at least one of the first pressure-calculation map and the second pressure-calculation map can be calibrated easily and accurately. Thus, the precision of sensing of the differential pressure between the supply-pressure sensor and the first or second-load-pressure sensor is improved, so it becomes possible to accurately control the hydraulic actuator.

### Advantages of the Invention

According to the present invention, in construction machines such as hydraulic excavators, it becomes possible to calibrate a pressure sensor easily and accurately to thereby control hydraulic actuators accurately.

### BRIEF DESCRIPTION OF THE DRAWINGS

FIG. 1 is a figure schematically illustrating the external appearance of a hydraulic excavator which is one example of construction machines according to an embodiment of the present invention.

FIG. 2 is a figure schematically illustrating a hydraulic-actuator control system mounted on the hydraulic excavator.

FIG. 3 is a functional block diagram illustrating details of a controller.

FIG. 4 is a flowchart illustrating a calculation process of a control-mode calculating section.

FIG. 5 is a functional block diagram illustrating details of a valve control section.

FIG. 6A is a figure illustrating one example of a pressure-calculation map provided to a pressure calculating section.

FIG. 6B is a figure illustrating one example of a position-calculation map provided to a position calculating section.

FIG. 7 is a figure illustrating one example of a method of calibrating the position-calculation map.

FIG. 8 is a figure illustrating one example of a method of calibrating the pressure-calculation map.

FIG. 9 is a flowchart illustrating a calculation process of a maintenance-mode control section.

FIG. 10 is a figure illustrating operation of an A-port meter-in valve, a B-port meter-in valve, an A-port meter-out valve, a B-port meter-out valve, a first bleed-off valve and a second bleed-off valve in response to each mode command.

### MODES FOR CARRYING OUT THE INVENTION

Hereinafter, an embodiment of the present invention is explained with reference to the drawings. Note that equivalent members are given identical reference characters through the drawings, and overlapping explanations are omitted as appropriate.

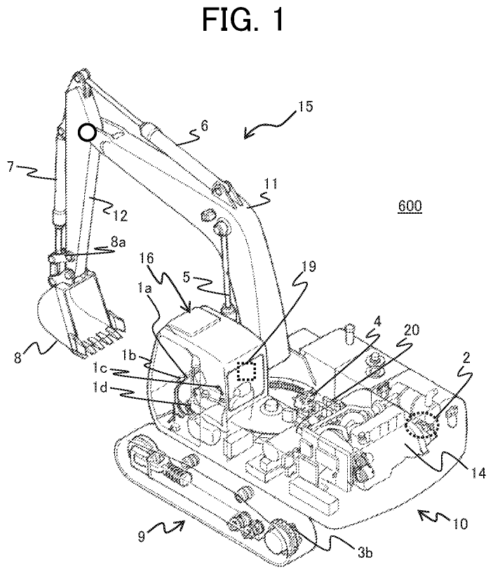

FIG. 1 is a figure schematically illustrating the external appearance of a hydraulic excavator as one example of construction machines according to the present embodiment.

In FIG. 1, a hydraulic excavator 600 includes: an articulated-type front implement (front work implement) 15 including a plurality of interconnected driven members (a boom 11, an arm 12 and a bucket (work device) 8) that individually pivot vertically; and an upper swing structure 10 and a lower track structure 9 that constitute at least part of the machine-body. The upper swing structure 10 is swingably provided to the lower track structure 9. In addition, the base end of the boom 11 of the front implement 15 is vertically pivotably supported at a front portion of the upper swing structure 10, one end of the arm 12 is vertically pivotably supported at an end portion (tip) of the boom 11 which is different from the base end, and the bucket 8 is vertically pivotably supported at the other end of the arm 12 via a bucket link 8a. The boom 11, the arm 12, the bucket 8, the upper swing structure 10 and the lower track structure 9 are driven by a boom cylinder 5, an arm cylinder 6, a bucket cylinder 7, a swing hydraulic motor 4 and left and right traveling hydraulic motors 3b (only one traveling hydraulic motor is illustrated) which are hydraulic actuators, respectively.

In a cab 16 on which an operator gets, a right operation lever device 1c and a left operation lever device 1d which are operation levers (operation devices) that output operation signals for operating the hydraulic actuators 5 to 7 of the front implement 15, and the swing hydraulic motor 4 of the upper swing structure 10, and a travel right operation lever device 1a and a travel left operation lever device 1b that output operation signals for operating the left and right traveling hydraulic motors 3b of the lower track structure 9 are provided.

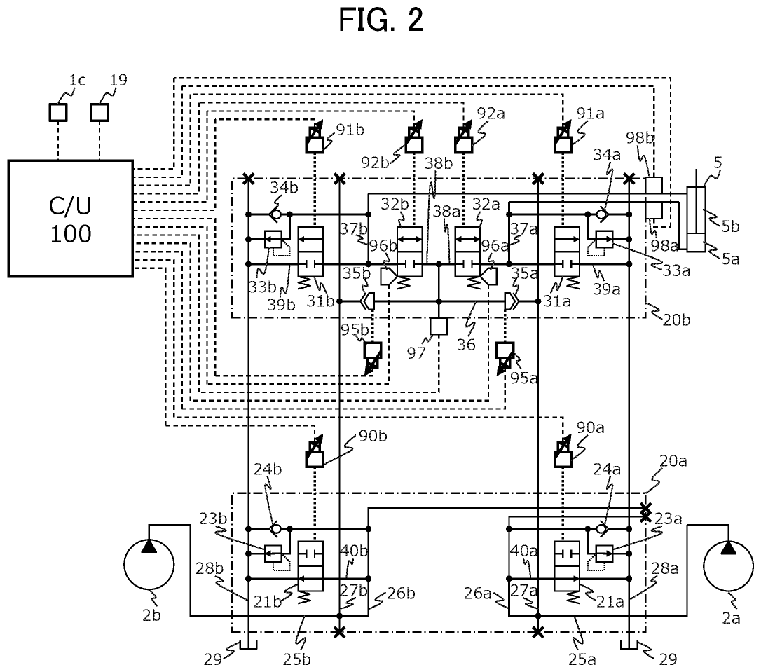

The left and right operation lever devices 1c and 1d are each an electric operation lever device that outputs an electric signal as an operation signal, and has an operation lever operated to be inclined forward, backward, leftward and rightward by the operator, and an electric signal generating section that generates an electric signal according to the inclination direction and the inclination amount (lever operation amount) of the operation lever. Electric signals output from the operation lever devices 1c and 1d are input to a controller 100 (illustrated in FIG. 2) via electric wires. In the present embodiment, operation of the operation lever of the right operation lever device 1c in the forward and backward directions corresponds to operation of the boom cylinder 5, and operation of the same operation lever in the leftward and rightward directions corresponds to operation of the bucket cylinder 7. On the other hand, operation of the operation lever of the left operation lever device 1c in the forward and backward directions corresponds to operation of the swing hydraulic motor 4, and operation of the same operation lever in the leftward and rightward directions corresponds to operation of the arm cylinder 6.

Operation control of the boom cylinder 5, the arm cylinder 6, the bucket cylinder 7, the swing hydraulic motor 4 and the left and right traveling hydraulic motors 3b is performed by control, by means of a control valve 20, of the direction and flow rate of a hydraulic operating fluid supplied from a hydraulic pump apparatus 2 driven by a prime mover (an engine 14 in the present embodiment) such as an engine or an electric motor to the individual hydraulic actuators 3b and 4 to 7.

The control valve 20 is driven by a drive signal (pilot pressure) output from a pilot pump, which is not illustrated, via a pilot valve and a solenoid proportional valve. By the pilot pressure being output from the pilot valve to the control valve 20 in conjunction with operation of the travel right operation lever device 1a and the travel left operation lever device 1b, operation of the left and right traveling hydraulic motors 3b of the lower track structure 9 is controlled. In addition, by the solenoid proportional valve being controlled by the controller 100 on the basis of operation signals output from the operation lever devices 1c and 1d, operation of the individual hydraulic actuators 3b and 4 to 7 is controlled. The boom 11 pivots in the upward and downward directions relative to the upper swing structure 10 due to extension and contraction of the boom cylinder 5, the arm 12 pivots in the upward and downward directions and the forward and backward directions relative to the boom 11 due to extension and contraction of the arm cylinder 6, and the bucket 8 pivots in the upward and downward directions and the forward and backward directions relative to the arm 12 due to extension and contraction of the bucket cylinder 7.

FIG. 2 is a figure schematically illustrating a hydraulic-actuator control system mounted on the hydraulic excavator 600.

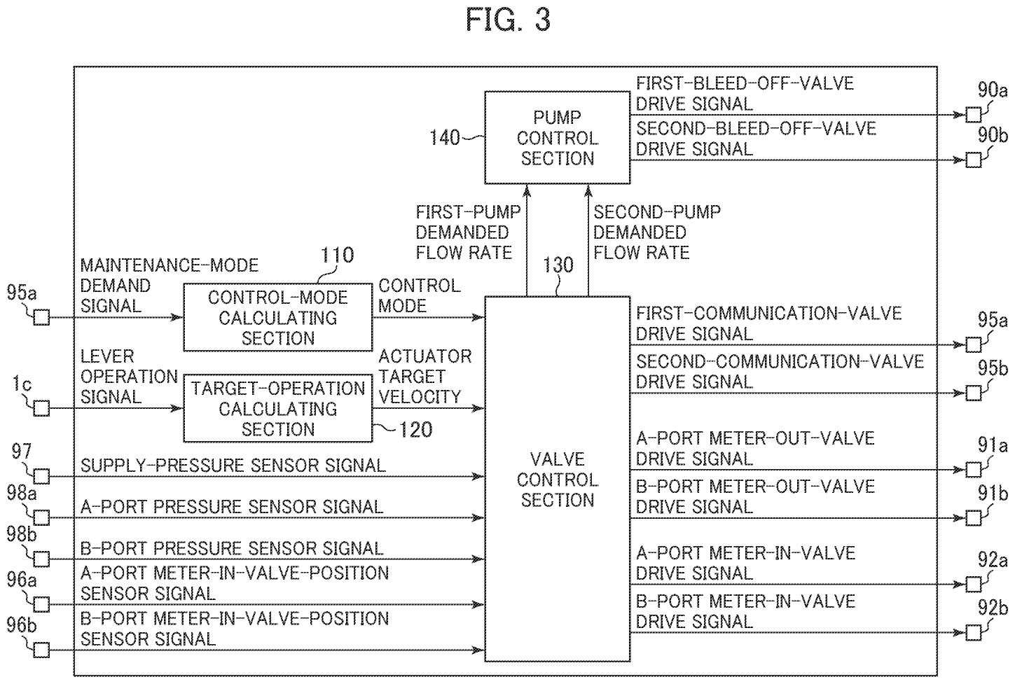

In FIG. 2, the hydraulic-actuator control system includes the controller 100 as a control device for controlling operation of the hydraulic excavator 600, and the control valve 20 that drives the boom cylinder 5. Note that in order to simplify the explanation, only a bleed-off section 20a and a boom section 20b of the control valve 20 are described and explained in FIG. 2, and description and explanation of other sections are omitted. In addition, similarly, in FIG. 3 also, the content related to the bleed-off section and the boom section is described and explained, and description and explanation of other sections are omitted.

The bleed-off section 20a of the control valve 20 is provided with a supply hydraulic line 25a (25b), and is supplied with a hydraulic fluid from the first hydraulic pump 2a (second hydraulic pump 2b). The supply hydraulic line 25a (25b) branches into a supply hydraulic line 26a (27a) and a supply hydraulic line 26b (27b), the supply hydraulic line 26a (26b) is connected to a discharge hydraulic line 28a (28b) via a first bleed-off valve 21a (second bleed-off valve 21b), a main relief valve 23a (23b), and a makeup valve 24a (24b), and the discharge hydraulic line 28a (28b) is connected to a tank 29. The first bleed-off valve 21a (second bleed-off valve 21b) is driven by a first bleed-off solenoid valve 90a (second bleed-off solenoid valve 90b), establishes communication between the supply hydraulic line 26a (26b) and the discharge hydraulic line 28a (28b), and bleeds off the hydraulic fluid from the first hydraulic pump 2a (second hydraulic pump 2b). On the other hand, the supply hydraulic line 27a (27b) is connected to the boom section 20b, and supplies the hydraulic fluid from the first hydraulic pump 2a (second hydraulic pump 2b) to the boom section 20b.

In the boom section 20b, the supply hydraulic line 27a (27b) branches into a branch hydraulic line 36, and a communication control valve 35a (35b) is provided on the branch hydraulic line 36. The communication control valve 35a (35b) is a check valve that prevents the flow of the hydraulic fluid from the branch hydraulic line 36 into the supply hydraulic line 27a (27b), and additionally is configured to be driven by a first communication solenoid valve 95a (second communication solenoid valve 95b) so as to be able to interrupt the flow of the hydraulic fluid from the supply hydraulic line 27a (27b) to the branch hydraulic line 36. In addition, the branch hydraulic line 36 is connected to an actuator hydraulic line 37a (37b) via a connection hydraulic line 38a (38b). On the connection hydraulic line 38a (38b), an A-port meter-in valve 32a (B-port meter-in valve 32b) is provided. The actuator hydraulic line 37a (37b) is connected to a bottom-side oil chamber 5a (rod-side oil chamber 5b) of the boom cylinder 5, and is connected to the discharge hydraulic line 28a (28b) via an over-load relief valve 33a (33b) and a makeup valve 34a (34b). In addition, the actuator hydraulic line 37a (37b) is connected to the discharge hydraulic line 28a (28b) via a connection hydraulic line 39a (39b). On the connection hydraulic line 39a (39b), an A-port meter-out valve 31a (B-port meter-out valve 31b) is provided. Therefore, by driving and thereby opening the A-port meter-in valve 32a (B-port meter-in valve 32b) by an A-port meter-in solenoid valve 92a (B-port meter-in solenoid valve 92b), the hydraulic fluid from the first hydraulic pump 2a (second hydraulic pump 2b) can be supplied to the boom cylinder 5. In addition, by driving and thereby opening the A-port meter-out valve 31a (B-port meter-out valve 31b) by an A-port meter-out solenoid valve 91a (B-port meter-out solenoid valve 91b), the hydraulic fluid of the boom cylinder 5 can be discharged to the tank 29 via the discharge hydraulic line 28a (28b).

The controller 100 receives inputs of a lever operation signal from the right operation lever device 1c, a maintenance-mode demand signal from a maintenance mode switch 19, a supply-pressure sensor signal from a supply-pressure sensor (supply-pressure sensor) 97 installed on the branch hydraulic line 36, an A-port pressure sensor signal and a B-port pressure sensor signal from an A-port pressure sensor 98a and a B-port pressure sensor 98b installed on the actuator hydraulic lines 37a and 37b, and an A-port meter-in-valve-position sensor signal and a B-port meter-in-valve-position sensor signal from an A-port meter-in-valve-position sensor 96a and a B-port meter-in-valve-position sensor 96b installed on the A-port meter-in valve 32a and the B-port meter-in valve 32b. Further, on the basis of these inputs, the controller 100 drives the A-port meter-in solenoid valve 92a, the B-port meter-in solenoid valve 92b, the A-port meter-out solenoid valve 91a, the B-port meter-out solenoid valve 91b, the first communication solenoid valve 95a, the second communication solenoid valve 95b, the first bleed-off solenoid valve 90a and the second bleed-off solenoid valve 90b.

Here, the controller 100 supports an actuator operation mode for driving actuators such as the boom cylinder 5, and a maintenance mode for performing calibration of the A-port meter-in-valve-position sensor 96a, the B-port meter-in-valve-position sensor 96b, the A-port pressure sensor 98a and the B-port pressure sensor 98b. The maintenance mode switch 19 is a switch that outputs an electric signal of instruction for switching the control mode from the actuator operation mode to the maintenance mode, and may be a push switch that is to be operated manually. In addition, the maintenance mode switch 19 may instead be a configuration that outputs a signal for switching the control mode to the maintenance mode from a terminal for maintenance.

FIG. 3 is a functional block diagram illustrating details of the controller 100.

In FIG. 3, the controller 100 has a control-mode calculating section 110, a target-operation calculating section 120, a valve control section 130 and a pump control section 140.

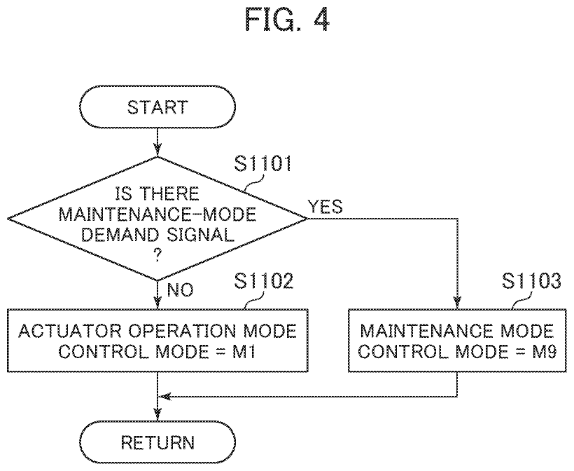

FIG. 4 is a flowchart illustrating a calculation process of the control-mode calculating section 110. At Step S1101, the control-mode calculating section 110 decides whether or not there is a maintenance-mode demand signal. The control-mode calculating section 110 proceeds to Step S1102 in a case where there are no maintenance-mode demand signals, and proceeds to Step S1103 in a case where there is a maintenance-mode demand signal. At Step S1102, the control mode is set to a control mode M1 representing the actuator operation mode. In addition, at Step S1103, the control mode is set to a control mode M9 representing the maintenance mode. Note that the maintenance mode is further divided into a plurality of control modes, and details thereof are mentioned below.

With reference again to FIG. 3, the target-operation calculating section 120 calculates an actuator target velocity on the basis of a lever operation signal from the right operation lever device 1c, and transmits the actuator target velocity to the valve control section 130. For example, as the right operation lever device 1c is inclined backward relative to the machine-body increases, the actuator target velocity may be increased positively, and as the right operation lever device 1c is inclined forward relative to the machine-body increases, the actuator target velocity may be increased negatively.

On the basis of the control mode from the control-mode calculating section 110, the actuator target velocity from the target-operation calculating section 120, the supply-pressure sensor signal from the supply-pressure sensor 97, the A-port pressure sensor signal and the B-port pressure sensor signal from the A-port pressure sensor 98a and the B-port pressure sensor 98b, and the A-port meter-in-valve-position sensor signal and the B-port meter-in-valve-position sensor signal from the A-port meter-in-valve-position sensor 96a and the B-port meter-in-valve-position sensor 96b, respectively, the valve control section 130 calculates a first-pump demanded flow rate and a second-pump demanded flow rate, and outputs the first-pump demanded flow rate and the second-pump demanded flow rate to the pump control section 140. The valve control section 130 additionally calculates a first-communication-valve drive signal, a second-communication-valve drive signal, an A-port meter-out-valve drive signal, a B-port meter-out-valve drive signal, an A-port meter-in-valve drive signal and a B-port meter-in-valve drive signal, and outputs the first-communication-valve drive signal, the second-communication-valve drive signal, the A-port meter-out-valve drive signal, the B-port meter-out-valve drive signal, the A-port meter-in-valve drive signal and the B-port meter-in-valve drive signal to the first communication solenoid valve 95a, the second communication solenoid valve 95b, the A-port meter-out solenoid valve 91a, the B-port meter-out solenoid valve 91b, the A-port meter-in solenoid valve 92a and the B-port meter-in solenoid valve 92b, respectively. Note that the calculations performed by the valve control section 130 vary depending on the control mode, and calculations performed for the actuator operation mode, and calculations performed for the maintenance mode are separately mentioned below in detail.

On the basis of the first-pump demanded flow rate and the second-pump demanded flow rate from the valve control section 130, the pump control section 140 calculates a first-bleed-off-valve drive signal and a second-bleed-off-valve drive signal, and outputs the first-bleed-off-valve drive signal and the second-bleed-off-valve drive signal to the first bleed-off solenoid valve 90a and the second bleed-off solenoid valve 90b, respectively. For example, the first-bleed-off-valve drive signal (second-bleed-off-valve drive signal) may be calculated such that as the first-pump demanded flow rate (second-pump demanded flow rate) increases, the opening area of the bleed-off valve 21a (21b) decreases. In addition, the first hydraulic pump 2a (second hydraulic pump 2b) may be a variable displacement pump, and the delivery flow rate of the first hydraulic pump 2a (second hydraulic pump 2b) may be controlled on the basis of the first-pump demanded flow rate (second-pump demanded flow rate).

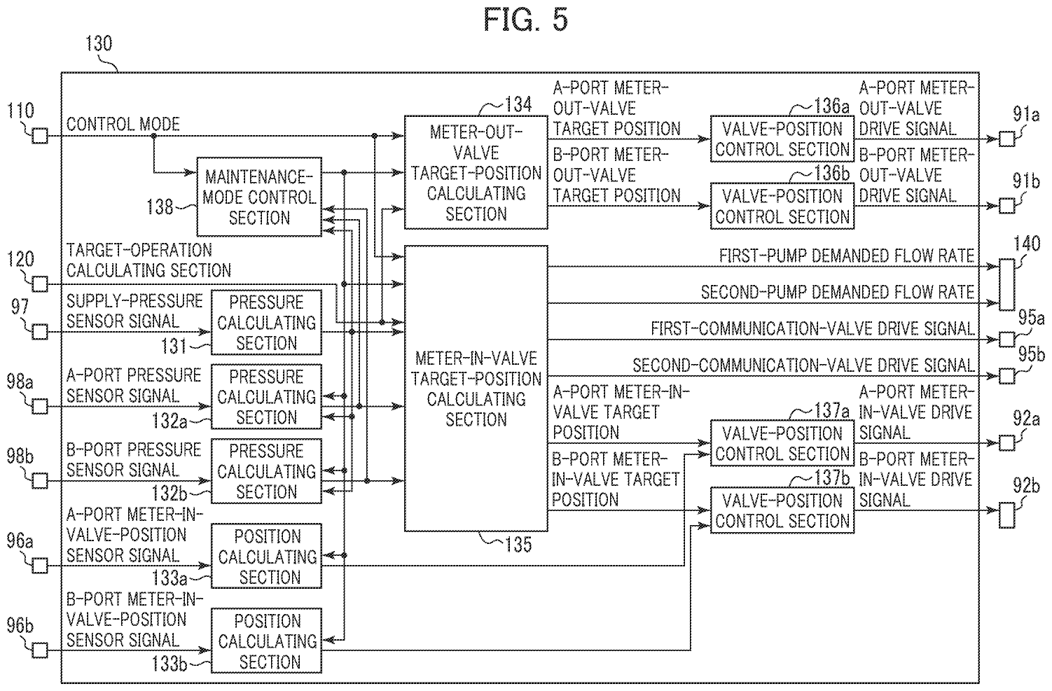

FIG. 5 is a functional block diagram illustrating details of the valve control section 130.

In FIG. 5, the valve control section 130 has: pressure calculating sections 131, 132a and 132b; position calculating sections 133a and 133b; a meter-out-valve target-position calculating section 134; a meter-in-valve target-position calculating section 135; valve-position control sections 136a, 136b, 137a and 137b; and a maintenance-mode control section 138.

Hereinafter, processes performed at the valve control section 130 are explained separately for the actuator operation mode and the maintenance mode.

<Actuator Operation Mode>

Processes performed at the valve control section 130 at the time of the actuator operation mode are explained.

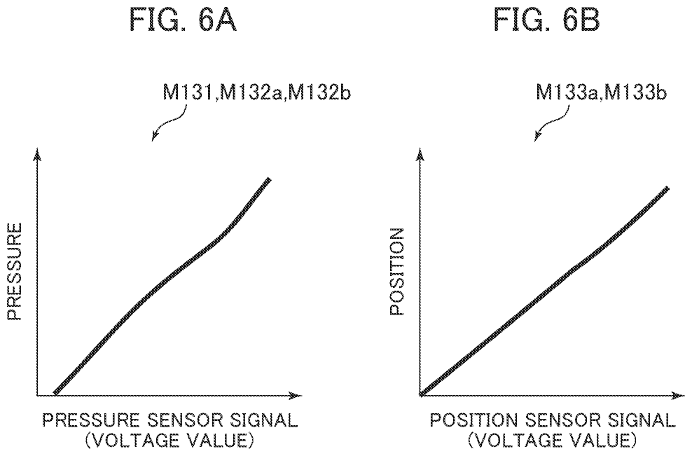

At the time of the actuator operation mode, the pressure calculating sections 131, 132a and 132b calculate a supply pressure, an A-port pressure and a B-port pressure on the basis of the supply-pressure sensor signal, the A-port pressure sensor signal and the B-port pressure sensor signal, and outputs the supply pressure, the A-port pressure and the B-port pressure. Specifically, on the basis of a map for calculation (supply-pressure-calculation map) M131 like the one illustrated in FIG. 6A, the pressure calculating section (supply-pressure calculating section) 131 converts the voltage value of the supply-pressure sensor signal into a pressure, and outputs the pressure. Similarly, on the basis of a map for pressure calculation (first pressure-calculation map) M132a, the pressure calculating section (first pressure calculating section) 132a converts the voltage value of the A-port pressure sensor signal into an A-port pressure, and outputs the A-port pressure. On the basis of a map for pressure calculation (second pressure-calculation map) M132b, the pressure calculating section (second pressure calculating section) 132b converts the voltage value of the B-port pressure sensor signal into a B-port pressure, and outputs the B-port pressure. Note that the pressure-calculation maps M131, M132a and M132b are set individually in accordance with the characteristics and/or attachment states of the supply-pressure sensor 97, the A-port pressure sensor 98a and the B-port pressure sensor 98b.

In addition, at the time of the actuator operation mode, on the basis of the A-port meter-in-valve-position sensor signal and the B-port meter-in-valve-position sensor signal, the position calculating sections 133a and 133b, respectively, calculate an A-port meter-in valve position and a B-port meter-in-valve position, and output the A-port meter-in valve position and the B-port meter-in-valve position. Specifically, on the basis of a position-calculation map (first position-calculation map) M133a like the one illustrated in FIG. 6B, the position calculating section (first position calculating section) 133a converts the voltage value of the A-port meter-in-valve-position sensor signal into an A-port meter-in valve position, and outputs the A-port meter-in valve position. Similarly, on the basis of a position-calculation map (second position-calculation map) M132b, the position calculating section (second position calculating section) 133b converts the voltage value of the B-port meter-in-valve-position sensor signal into a valve position, and outputs the valve position.

At the time of the actuator operation mode, on the basis of the actuator target velocity, the meter-out-valve target-position calculating section 134 calculates an A-port meter-out-valve target position and a B-port meter-out-valve target position.

Here, in FIG. 2, an A port of the boom section 20b is connected to the bottom-side oil chamber 5a of the boom cylinder 5, and a B port of the boom section 20b is connected to the rod-side oil chamber 5b of the boom cylinder 5. At this time, for example, in a case where the actuator target velocity is a positive velocity, an actuator discharge flow rate is calculated by multiplying the actuator target velocity by the effective area of the rod-side oil chamber 5b of the boom cylinder 5, and the B-port meter-out-valve target position is calculated on the basis of the actuator discharge flow rate, and output. In addition, in a case where the actuator target velocity is a negative velocity, the actuator discharge flow rate is calculated by multiplying the actuator target velocity by the effective area of the bottom-side oil chamber 5a of the boom cylinder 5, and the A-port meter-out-valve target position is calculated on the basis of the actuator discharge flow rate, and output. These calculations are performed at the meter-out-valve target-position calculating section 134.

At the time of the actuator operation mode, on the basis of the actuator target velocity, the supply pressure, the A-port pressure and the B-port pressure, the meter-in-valve target-position calculating section 135 calculates an A-port meter-in-valve target position, a B-port meter-in-valve target position, the first-pump demanded flow rate, the second-pump demanded flow rate, the first-communication-valve drive signal and the second-communication-valve drive signal.

Here, in FIG. 2, the A port of the boom section 20b is connected to the bottom-side oil chamber 5a of the boom cylinder 5, and the B port of the boom section 20b is connected to the rod-side oil chamber 5b of the boom cylinder 5. Accordingly, the bottom side and the rod side of the calculations mentioned before that are performed at the meter-out-valve target-position calculating section 134 are replaced with each other. For example, in a case where the actuator target velocity is a positive velocity, an actuator demanded flow rate is calculated by multiplying the actuator target velocity by the effective area of the bottom-side oil chamber 5a of the boom cylinder 5, and the A-port meter-in-valve target position is calculated on the basis of the actuator demanded flow rate and the difference between the supply pressure and the A-port pressure, and output. In addition, in a case where the actuator target velocity is a negative velocity, the actuator demanded flow rate is calculated by multiplying the actuator target velocity by the effective area of the rod-side oil chamber 5b of the boom cylinder 5, and the B-port meter-in-valve target position is calculated on the basis of the actuator demanded flow rate and the difference between the supply pressure and the B-port pressure, and output.

In addition, regarding the first-pump demanded flow rate and the second-pump demanded flow rate calculated at the meter-in-valve target-position calculating section 135, for example, in a case where the actuator demanded flow rate is equal to or lower than the flow rate that can be supplied from the first hydraulic pump 2a, the first-pump demanded flow rate and the second-pump demanded flow rate may be set to the actuator demanded flow rate and 0, respectively. In addition, in a case where the actuator demanded flow rate is larger than the flow rate that can be supplied from the first hydraulic pump 2a, the first-pump demanded flow rate may be set to the maximum flow rate that can be supplied from the first hydraulic pump 2a, and the second-pump demanded flow rate may be set to a value obtained by subtracting, from the actuator demanded flow rate, the maximum flow rate that can be supplied from the first hydraulic pump 2a. In addition, the first-pump demanded flow rate and the second-pump demanded flow rate may each be set to half of the actuator demanded flow rate, and the manner of allocation to the first-pump demanded flow rate and the second-pump demanded flow rate is not limited to that in the present invention.

In addition, regarding the first-communication-valve drive signal and the second-communication-valve drive signal calculated at the meter-in-valve target-position calculating section 135, for example, if the first-pump demanded flow rate is 0, the first-communication-valve drive signal may be output to close the communication control valve 35a, and if the second-pump demanded flow rate is 0, the second-communication-valve drive signal may be output to close the communication control valve 35b.

Here, in a case where the load pressure on the actuator is higher than the supply pressure, the hydraulic fluid cannot be caused to flow to the actuator, and the actuator target velocity cannot be attained. That is, in order to surely attain the actuator target velocity, it is necessary to sufficiently increase the supply pressure relative to the load pressure on the actuator. In view of this, the meter-in-valve target-position calculating section 135 corrects the actuator demanded flow rate in accordance with the load pressure, and increases the supply pressure. For example, in a case where the actuator target velocity is a positive (negative) velocity, the meter-in-valve target-position calculating section 135 corrects the actuator demanded flow rate in accordance with the difference between the supply pressure and the A-port pressure (B-port pressure) such that the actuator demanded flow rate increases as the difference decreases, so as to make the supply pressure higher than the A-port pressure (B-port pressure). Thus, the first-pump demanded flow rate and the second-pump demanded flow rate calculated on the basis of the actuator demanded flow rate increase also. As a result, the first-bleed-off-valve drive signal and the second-bleed-off-valve drive signal are calculated at the pump control section 140 such that the opening areas of the first bleed-off valve 21a and the second bleed-off valve 21b decrease, thus the supply pressure can be increased to thereby surely attain the actuator target velocity. These calculations are performed at the meter-in-valve target-position calculating section 135.

On the basis of the A-port meter-out-valve target position and the B-port meter-out-valve target position, the valve-position control sections 136a and 136b, respectively, calculate the A-port meter-out-valve drive signal and the B-port meter-out-valve drive signal, and output the A-port meter-out-valve drive signal and the B-port meter-out-valve drive signal.

Similarly, on the basis of the A-port meter-in-valve target position and the B-port meter-in-valve target position, the valve-position control section 137a and 137b, respectively, calculate the A-port meter-in-valve drive signal and the B-port meter-in-valve drive signal, and output the A-port meter-in-valve drive signal and the B-port meter-in-valve drive signal.

It should be noted however that the valve-position control sections 137a and 137b also receive inputs of the A-port meter-in valve position and the B-port meter-in-valve position from the position calculating sections 133a and 133b, and correct the A-port meter-in-valve drive signal and the B-port meter-in-valve drive signal, respectively, in accordance with the deviation between the A-port meter-in-valve target position and the A-port meter-in valve position, and the deviation between the B-port meter-in-valve target position and the B-port meter-in-valve position. Thus, the positions of the A-port meter-in valve and the B-port meter-in valve are controlled accurately.

<Maintenance Mode>

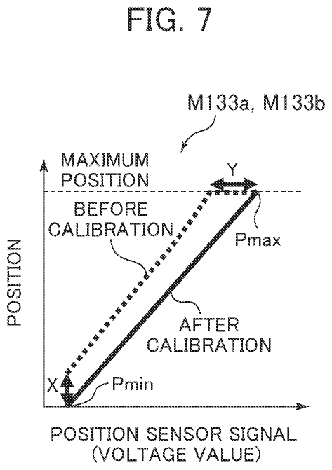

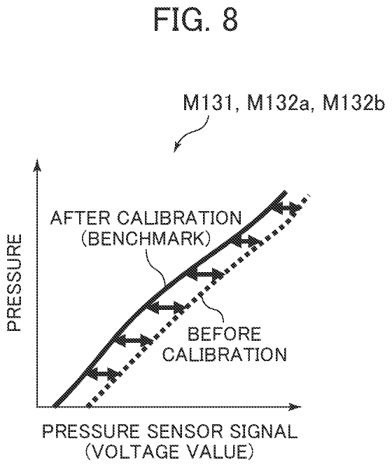

Processes to be performed at the valve control section 130 at the time of the maintenance mode are explained. In order to control the actuator accurately at the time of the actuator operation mode, in the maintenance mode, in accordance with an instruction by the maintenance-mode control section 138, calculation processes of the meter-out-valve target-position calculating section 134 and the meter-in-valve target-position calculating section 135 are performed, and additionally errors of the A-port meter-in-valve-position sensor 96a, the B-port meter-in-valve-position sensor 96b, the A-port pressure sensor 98a and the B-port pressure sensor 98b are calibrated. For example, as illustrated in FIG. 7, in a contactless position sensor such as an LVDT, an error (indicated by the arrow X in FIG. 7) is generated in a minimum position due to the misalignment of the attachment position, and an error (indicated by the arrow Y in FIG. 7) is generated in a maximum position due to variation in power-supply voltage resulting from resistance value of power-supply line. Therefore, it is necessary to calibrate the maps M133a and M133b for calculation provided to the position calculating sections 133a and 133b, respectively. In addition, as illustrated in FIG. 8, errors are generated in pressure sensor signals of the pressure sensors 97, 98a and 98b relative to true pressures due to individual variations. Therefore, in order to sense pressure differences accurately, it is necessary to rewrite and calibrate the maps M132a and M132b for calculation, which are provided to the pressure calculating sections 132a and 132b, such that outputs of the maps M132a and M132b match outputs of the supply-pressure sensor 97 which serves as a reference sensor.

The valve control section 130 according to the present embodiment includes the following maintenance-mode control section 138 in order to perform calibration of the position sensors and calibration of the pressure sensors.

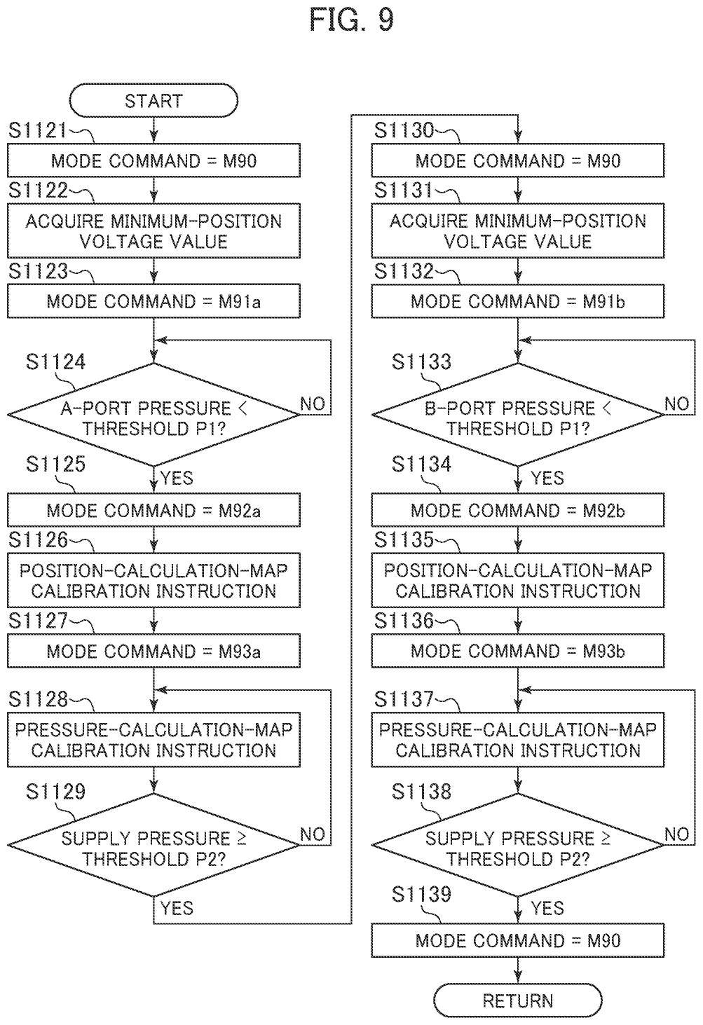

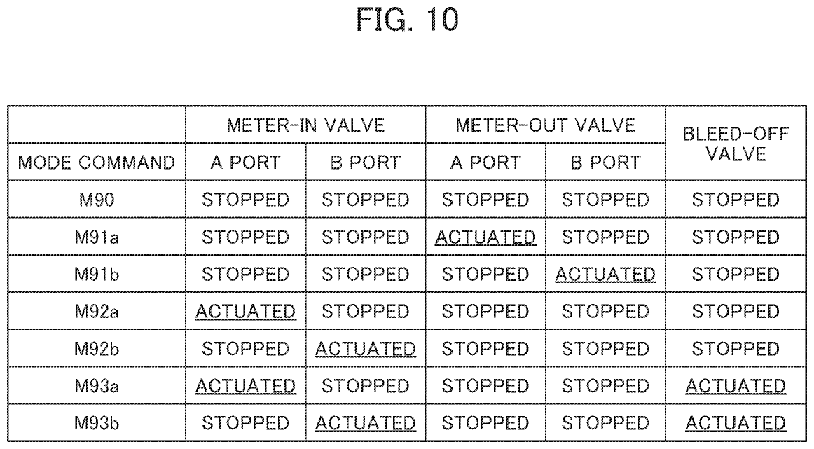

FIG. 9 is a flowchart illustrating a calculation process of the maintenance-mode control section 138, and FIG. 10 is a figure illustrating operation of the A-port meter-in valve 32a, the B-port meter-in valve 32b, the A-port meter-out valve 31a, the B-port meter-out valve 31b, the first bleed-off valve 21a and the second bleed-off valve 21b, in response to each mode command.

In FIG. 9, at Step S1121, the control mode is set to M90. The control mode M90 is a stop mode, and a maintenance mode command is output to the meter-out-valve target-position calculating section 134 and the meter-in-valve target-position calculating section 135 such that all of the meter-in valves 32a and 32b, the meter-out valves 31a and 31b and the bleed-off valves 21a and 21b stop at the initial positions. In response to reception of the maintenance mode command, the meter-out-valve target-position calculating section 134 calculates the A-port meter-out-valve target position and the B-port meter-out-valve target position as zero, and the meter-in-valve target-position calculating section 135 calculates the A-port meter-in-valve target position and the B-port meter-in-valve target position as zero. In addition, at the meter-in-valve target-position calculating section 135, the first-pump target flow rate and the second-pump target flow rate are calculated as zero. As a result, as illustrated in FIG. 10, in the control mode M90, all of the A-port meter-in valve 32a, the B-port meter-in valve 32b, the A-port meter-out valve 31a, the B-port meter-out valve 31b, the first bleed-off valve 21a and the second bleed-off valve 21b are stopped at the initial positions.

At Step S1122, the voltage value of the A-port meter-in-valve-position sensor 96a is acquired, and stored as a minimum-position voltage value.

At Step S1123, the control mode is set to M91a. The control mode M91a is a depressurization mode, and a maintenance mode command is output to the meter-out-valve target-position calculating section 134 such that only the meter-out valve 31a is actuated, and the pressure of the bottom-side oil chamber 5a of the boom cylinder 5 is lowered. In response to reception of the maintenance mode command, the meter-out-valve target-position calculating section 134 calculates the A-port meter-out-valve target position as a value larger than 0. As a result, as illustrated in FIG. 10, the A-port meter-out valve 31a is actuated, and the bottom-side oil chamber 5a of the boom cylinder 5 communicates with the tank 29 in FIG. 2. Thus, the bottom-side pressure of the boom cylinder 5, that is, the A-port pressure, is lowered.

At Step S1124, it is decided whether or not the A-port pressure is equal to or lower than a threshold P1 (e.g. the atmospheric pressure). If the A-port pressure is equal to or lower than the threshold P1, the process proceeds to Step S1125, and if the A-port pressure is not equal to or lower than the threshold P1, the control mode M91a continues.

At Step S1125, the control mode is set to M92a. The control mode M92a is a maintenance mode for calibrating the A-port meter-in-valve-position sensor 96a. The maintenance-mode control section 138 outputs a maintenance mode command to the meter-out-valve target-position calculating section 134 and the meter-in-valve target-position calculating section 135. In response to reception of the maintenance mode command, the meter-in-valve target-position calculating section 135 calculates the A-port meter-in-valve target position as the maximum position. In addition, the meter-in-valve target-position calculating section 135 calculates the first-pump demanded flow rate and the second-pump demanded flow rate still as zero. Furthermore, the meter-out-valve target-position calculating section 134 calculates the A-port meter-out-valve target position as zero. As a result, as illustrated in FIG. 10, the A-port meter-in valve 32a is actuated to move to the maximum position, and the A-port meter-out valve 31a is stopped at the initial position. In addition, the first bleed-off valve 21a and the second bleed-off valve 21b remain stopped at the initial positions.

At the subsequent Step S1126, the voltage value of the A-port meter-in-valve-position sensor 96a when the A-port meter-in valve 32a is at the maximum position is acquired, and stored as a maximum-position voltage value. The maintenance-mode control section 138 further outputs, to the position calculating section 133a, the minimum-position voltage value stored at Step S1122, the maximum-position voltage value stored at the current step, and a position-calculation-map calibration instruction. As illustrated in FIG. 7, the position calculating section 133a having received the position-calculation-map calibration instruction sets a map linearly complemented between a point Pmin, which is determined by the minimum-position voltage value and the minimum position, and a point Pmax, which is determined by the maximum-position voltage value and the maximum position, as the position-calculation map M133a after calibration. At this time, since the pressure acting on the A-port meter-in valve 32a is low, and also the flow rate passing through the A-port meter-in valve 32a is not generated, the maximum position of the A-port meter-in-valve-position sensor 96a can be acquired in a state in which the influence of pressure or hydrodynamic force is kept small. As a result, it becomes possible to precisely calibrate the position-calculation map M133a.

At Step S1127, the control mode is set to M93a. The control mode M93a is a pressure sensor calibration mode, and a maintenance mode command is output to the meter-in-valve target-position calculating section 135 such that the pressure sensors are calibrated while the bleed-off valves are actuated to increase the pressure. The meter-in-valve target-position calculating section 135 calculates the first-pump target flow rate and the second-pump target flow rate such that the first-pump target flow rate and the second-pump target flow rate increase gradually. As a result, as illustrated in FIG. 10, while the A-port meter-out valve 31a, the B-port meter-out valve 31b and the B-port meter-in valve 32b have stopped at the initial positions, and while the A-port meter-in valve 32a has been actuated to move to the maximum position, the first bleed-off valve 21a and the second bleed-off valve 21b are actuated to gradually increase the delivery pressures of the first hydraulic pump 2a and the second hydraulic pump 2b.

At Step S1128, the maintenance-mode control section 138 outputs a pressure-calculation-map calibration instruction to the position calculating section 133a. As illustrated in FIG. 7, the pressure calculating section 132a having received the pressure-calculation-map calibration instruction rewrites the position-calculation map M132a such that the pressure corresponding to the A-port pressure sensor signal matches the supply pressure calculated at the pressure calculating section 131. At this time, in FIG. 2, the hydraulic fluid delivered from the first hydraulic pump 2a and the second hydraulic pump 2b passes through the A-port meter-in valve 32a to flow into the bottom-side oil chamber 5a of the boom cylinder 5. However, since both the A-port meter-out valve 31a and the B-port meter-out valve 31b are stopped at the initial positions, operation of the boom cylinder 5 is suppressed, both the bottom-side and rod-side pressures of the boom cylinder 5 increase, and the flow rate passing through the A-port meter-in valve 32a is reduced. In addition, by installing the supply-pressure sensor 97 on a hydraulic line portion which is of a hydraulic line connecting the first hydraulic pump 2a or the second hydraulic pump 2b, and the A-port meter-in valve 32a or the B-port meter-in valve 32b, the hydraulic line portion excluding a hydraulic line portion connecting the first hydraulic pump 2a or the second hydraulic pump 2b, and the first bleed-off valve 21a or the second bleed-off valve 21b, the flow rate passing through the passage on which the supply-pressure sensor 97 is installed is reduced also. As a result, pressure loss barely occurs, and the supply pressure and the A-port pressure become nearly equal to each other. Accordingly, on the basis of the supply pressure, the pressure calculating section 132a can precisely calibrate the map M132a for calculating the A-port pressure from the A-port pressure sensor signal.

At Step S1129, it is decided whether or not the supply pressure is equal to or greater than a threshold P2 (e.g. a relief pressure). If the supply pressure is equal to or greater than the threshold P2, the process proceeds to Step S1130, and if the supply pressure is not equal to or greater than the threshold P2, the control mode M93a continues. Thus, at the pressure calculating section 132a, the map M132a for calculating the A-port pressure from the A-port pressure sensor signal can be calibrated over a wide range on the basis of the supply pressure.

At Step S1130, the control mode is set to the control mode M90 (stop mode) again. Thereafter, processes from Step S1131 to Step S1138, which is similar to the processes from Step S1122 to Step S1129, are performed on the side of the B port, and the control mode is set to the control mode M90 at Step S1139, and then the maintenance mode ends.

As mentioned above, in the present embodiment, there is provided the hydraulic excavator 600 including: the hydraulic pumps 2a and 2b; the supply hydraulic lines 27a and 27b connected to the hydraulic pumps 2a and 2b; the tank 29; the discharge hydraulic lines 28a and 28b connected to the tank 29; the hydraulic actuator 5 having the first oil chamber 5a and the second oil chamber 5b; the first-actuator hydraulic line 37a connected to the first oil chamber 5a; the second-actuator hydraulic line 37b connected to the second oil chamber 5b; the first meter-in valve 32a provided on the first connection hydraulic line 38a connecting the supply hydraulic lines 27a and 27b and the first-actuator hydraulic line 37a; the second meter-in valve 32b provided on the second connection hydraulic line 38b connecting the supply hydraulic lines 27a and 27b and the second-actuator hydraulic line 37b; the first meter-out valve 31a provided on the third connection hydraulic line 39a connecting the first-actuator hydraulic line 37a and the discharge hydraulic lines 28a and 28b; the second meter-out valve 31b provided on the fourth connection hydraulic line 39b connecting the second-actuator hydraulic line 37b and the discharge hydraulic lines 28a and 28b; the bleed-off valves 21a and 21b provided on fifth connection hydraulic lines 40a and 40b connecting the supply hydraulic lines 27a and 27b and the discharge hydraulic lines 28a and 28b; the supply-pressure sensor 97 that senses the delivery pressures of the hydraulic pumps 2a and 2b; the first-load-pressure sensor 98a that senses the pressure of the first oil chamber 5a; the second-load-pressure sensor 98b that senses the pressure of the second oil chamber 5b; and the controller 100 that controls the first and second meter-in valves 32a and 32b, the first and second meter-out valves 31a and 31b, and the bleed-off valves 21a and 21b in accordance with sensing signals of the first and second-load-pressure sensors 98a and 98b, and a sensing signal of the supply-pressure sensor 97. In the hydraulic excavator 600, the controller 100 calculates the delivery pressures of the hydraulic pumps 2a and 2b from the sensing signal of the supply-pressure sensor 97 on the basis of the supply-pressure-calculation map M131 representing a characteristic of the supply-pressure sensor 97, calculates the pressure of the first oil chamber 5a from the sensing signal of the first-load-pressure sensor 98a on the basis of the first pressure-calculation map M132a representing a characteristic of the first-load-pressure sensor 98a, and calculates the pressure of the second oil chamber 5b from the sensing signal of the second-load-pressure sensor 98b on the basis of the second pressure-calculation map M132b representing a characteristic of the second-load-pressure sensor 98b. Further, the controller 100 closes the bleed-off valves 21a and 21b (increases the delivery pressures of the hydraulic pumps 2a and 2b) in a state in which the first and second meter-out valves 31a and 31b and the second meter-in valve 32b are closed and in which the first meter-in valve 32a is opened, and calibrates the first pressure-calculation map M132a such that the pressure calculated on the basis of the first pressure-calculation map M132a matches the pressure calculated on the basis of the supply-pressure-calculation map M131. Furthermore, the controller 100 closes the bleed-off valves 21a and 21b (increases the delivery pressures of the hydraulic pumps 2a and 2b) in a state in which the first and second meter-out valves 31a and 31b and the first meter-in valve 32a are closed and in which the second meter-in valve 32b is opened, and calibrates the second pressure-calculation map M132b such that the pressure calculated on the basis of the second pressure-calculation map M132b matches the pressure calculated on the basis of the supply-pressure-calculation map M131.

In addition, the hydraulic excavator 600 according to the present embodiment further includes: the first-valve-position sensor 96a that senses the valve position of the first meter-in valve 32a; and the second-valve-position sensor 96b that senses the valve position of the second meter-in valve 32b. The controller 100 calculates the valve position of the first meter-in valve 32a from a sensing signal of the first-valve-position sensor 96a on the basis of the first position-calculation map M133a representing a characteristic of the first-valve-position sensor 96a, and calculates the valve position of the second meter-in valve 32b from a sensing signal of the second-valve-position sensor 96b on the basis of the second position-calculation map M133b representing a characteristic of the second-valve-position sensor 96b. The controller 100 actuates the first meter-in valve 32a in a state in which the first and second meter-out valves 31a and 31b and the second meter-in valve 32b are closed, and calibrates the first position-calculation map M133a such that the valve position calculated on the basis of the first position-calculation map M133a when the first meter-in valve 32a is at the minimum position becomes the minimum position, and the valve position calculated on the basis of the first position-calculation map M133a when the first meter-in valve 32a is at the maximum position becomes the maximum position. Alternatively, the controller 100 actuates the second meter-in valve 32b in a state in which the first and second meter-out valves 31a and 31b and the first meter-in valve 32a are closed, and calibrates the second position-calculation map M133b such that the valve position calculated on the basis of the second position-calculation map M133b when the second meter-in valve 32b is at the minimum position becomes the minimum position, and the valve position calculated on the basis of the second position-calculation map M133b when the second meter-in valve 32b is at the maximum position becomes the maximum position.

In addition, the controller 100 according to the present embodiment actuates the bleed-off valves 21a and 21b in a state in which the first and second meter-out valves 31a and 31b and the second meter-in valve 32b are closed and in which the first meter-in valve 32a is opened, and calibrates the first pressure-calculation map M132a such that the pressure calculated on the basis of the first pressure-calculation map M132a matches the pressure calculated on the basis of the supply-pressure-calculation map M131. Alternatively, the controller 100 according to the present embodiment actuates the bleed-off valves 21a and 21b in a state in which the first and second meter-out valves 31a and 31b, and the first meter-in valve 32a are closed, and the second meter-in valve 32b is opened, and calibrates the second pressure-calculation map M132b such that the pressure calculated on the basis of the second pressure-calculation map M132b matches the pressure calculated on the basis of the supply-pressure-calculation map M131.

According to the hydraulic excavator 600 according to the present embodiment, the A-port meter-in valve (first meter-in valve) 32a or the B port meter-in (second meter-in valve) valve 32b is actuated in a state in which the A-port meter-out valve (first meter-out valve) 31a and the B-port meter-out valve (second meter-out valve) 31b are closed, and at least one of the A-port pressure-calculation map (first pressure-calculation map) M132a, the B-port pressure-calculation map (second pressure-calculation map) M132b, the A-port position-calculation map (first position-calculation map) M133a, and the A-port position-calculation map (second position-calculation map) M133b can be calibrated easily and accurately. Thus, the precision of sensing by the A-port meter-in-valve-position sensor (first-valve-position sensor) 96a or the B-port meter-in-valve-position sensor (second-valve-position sensor) 96b or the precision of sensing of the differential pressure between the supply-pressure sensor (supply-pressure sensor) 97 and the A-port pressure sensor (first-load-pressure sensor) 98a or the B-port pressure sensor (second-load-pressure sensor) 98b is improved. Accordingly, it becomes possible to accurately control the boom cylinder (hydraulic actuator) 5.

Note that although, in the present embodiment, the bleed-off valves 21a and 21b are actuated to gradually increase the delivery pressures of the first hydraulic pump 2a and the second hydraulic pump 2b to thereby calibrate the pressure-calculation map M132a such that the pressure calculated at the pressure calculating section 132a matches the supply pressure calculated at the pressure calculating section 131 over a wide range of the delivery pressures of the first hydraulic pump 2a and the second hydraulic pump 2b, the maps M132a and M132b may be calibrated without actuating the bleed-off valves 21a and 21b, by calculating the differential pressure between pressures calculated at the pressure calculating sections 132a and 132b and a pressure calculated at the pressure calculating section 131, at one time point, and then shifting the maps M132a and M132b, which are maps before being calibrated, by the calculated differential pressure.

Although an embodiment of the present invention has been mentioned in detail thus far, the present invention is not limited to the embodiment described above, but includes various modification examples. For example, although in the embodiment described above, the present invention is applied to a hydraulic excavator including, as a work device, a bucket at the tip of the front work implement, the present invention is not limited to this, but also applicable to hydraulic excavators including work devices other than buckets or construction machines other than hydraulic excavators. In addition, the embodiment described above is explained in detail in order to explain the present invention in an easy-to-understand manner, and the present invention is not necessarily limited to the one including all the configurations explained.

### DESCRIPTION OF REFERENCE CHARACTERS

1a: Travel right operation lever device
1b: Travel left operation lever device
1c: Right operation lever device (operation device)
1d: Left operation lever device (operation device)
2: Hydraulic pump apparatus
2a: First hydraulic pump
2b: Second hydraulic pump
3b: Traveling hydraulic motor
3b: Hydraulic actuator
4: Swing hydraulic motor (hydraulic actuator)
5: Boom cylinder (hydraulic actuator)
5a: Bottom-side oil chamber (first oil chamber)
5b: Rod-side oil chamber (second oil chamber)
6: Arm cylinder (hydraulic actuator)
7: Bucket cylinder (hydraulic actuator)
8: Bucket (work device)
8a: Bucket link
9: Lower track structure
10: Upper swing structure
11: Boom
12: Arm
14: Engine (prime mover)
14: Engine
15: Front implement (front work implement)
16: Cab
19: Maintenance mode switch
20: Control valve
20a: Bleed-off section
20b: Boom section
21a: Bleed-off valve (first bleed-off valve)
21b: Bleed-off valve (second bleed-off valve)
23a: Main relief valve
23b: Main relief valve
24a: Makeup valve
24b: Makeup valve
25a: Supply hydraulic line
25b: Supply hydraulic line
26a: Supply hydraulic line
26b: Supply hydraulic line
27a: Supply hydraulic line
27b: Supply hydraulic line
28a: Discharge hydraulic line
28b: Discharge hydraulic line
29: Tank
31a: A-port meter-out valve
31b: B-port meter-out valve
32a: A-port meter-in valve
32b: B-port meter-in valve
33a: Over-load relief valve
33b: Over-load relief valve
34a: Makeup valve
34b: Makeup valve
35a: Communication control valve
35b: Communication control valve
36: Branch hydraulic line
37a: Actuator hydraulic line (first-actuator hydraulic line)
37b: Actuator hydraulic line (second-actuator hydraulic line)
38a: Connection hydraulic line (first connection hydraulic line)
38b: Connection hydraulic line (second connection hydraulic line)
39a: Connection hydraulic line (third connection hydraulic line)
39b: Connection hydraulic line (fourth connection hydraulic line)
40a: Connection hydraulic line (fifth connection hydraulic line)
40b: Connection hydraulic line (fifth connection hydraulic line)
90a: First bleed-off solenoid valve
90b: Second bleed-off solenoid valve
91a: A-port meter-out solenoid valve
91b: B-port meter-out solenoid valve
92a: A-port meter-in solenoid valve
92b: B-port meter-in solenoid valve
95a: First communication solenoid valve
95b: Second communication solenoid valve
96a: A-port meter-in-valve-position sensor (first-valve-position sensor)
96b: B-port meter-in-valve-position sensor (second-valve-position sensor)
97: Supply-pressure sensor (supply-pressure sensor)
98a: A-port pressure sensor (first-load-pressure sensor)
98b: B-port pressure sensor (second-load-pressure sensor)
100: Controller
110: Control-mode calculating section
120: Target-operation calculating section
130: Valve control section
131: Pressure calculating section (supply-pressure calculating section)
132a: Pressure calculating section (first pressure calculating section)
132b: Pressure calculating section (second pressure calculating section)
133a: Position calculating section (first position calculating section)
133b: Position calculating section (second position calculating section)
134: Meter-out-valve target-position calculating section
135: Meter-in-valve target-position calculating section
136a: Valve-position control section
136b: Valve-position control section
137a: Valve-position control section
137b: Valve-position control section
138: Maintenance-mode control section
140: Pump control section
600: Hydraulic excavator
M131: Supply-pressure-calculation map
M132a: A-port pressure-calculation map (first pressure-calculation map)
M132b: B-port pressure-calculation map (second pressure-calculation map)
M133a: A-port position-calculation map (first position-calculation map)
M133b: B-port position-calculation map (second position-calculation map)

1. A construction machine comprising:
a hydraulic pump;
a supply hydraulic line connected to the hydraulic pump;
a tank;
a discharge hydraulic line connected to the tank;
a hydraulic actuator having a first oil chamber and a second oil chamber;
a first-actuator hydraulic line connected to the first oil chamber;
a second-actuator hydraulic line connected to the second oil chamber;
a first meter-in valve provided on a first connection hydraulic line connecting the supply hydraulic line and the first-actuator hydraulic line;
a second meter-in valve provided on a second connection hydraulic line connecting the supply hydraulic line and the second-actuator hydraulic line;
a first meter-out valve provided on a third connection hydraulic line connecting the first-actuator hydraulic line and the discharge hydraulic line;
a second meter-out valve provided on a fourth connection hydraulic line connecting the second-actuator hydraulic line and the discharge hydraulic line;
a bleed-off valve provided on a fifth connection hydraulic line connecting the supply hydraulic line and the discharge hydraulic line;
a supply-pressure sensor that senses a delivery pressure of the hydraulic pump;
a first-load-pressure sensor that senses a pressure of the first oil chamber;
a second-load-pressure sensor that senses a pressure of the second oil chamber; and
a controller that controls the first and second meter-in valves, the first and second meter-out valves, and the bleed-off valve in accordance with sensing signals of the first and second-load-pressure sensors, and a sensing signal of the supply-pressure sensor, wherein
the controller is configured to
calculate the delivery pressure of the hydraulic pump from the sensing signal of the supply-pressure sensor on a basis of a supply-pressure-calculation map representing a characteristic of the supply-pressure sensor,
calculate the pressure of the first oil chamber from the sensing signal of the first-load-pressure sensor on a basis of a first pressure-calculation map representing a characteristic of the first-load-pressure sensor,
calculate the pressure of the second oil chamber from the sensing signal of the second-load-pressure sensor on a basis of a second pressure-calculation map representing a characteristic of the second-load-pressure sensor,
increase the delivery pressure of the hydraulic pump in a state in which the first and second meter-out valves and the second meter-in valve are closed and in which the first meter-in valve is opened, and calibrate the first pressure-calculation map such that the pressure calculated on the basis of the first pressure-calculation map matches the pressure calculated on the basis of the supply-pressure-calculation map, and
increase the delivery pressure of the hydraulic pump in a state in which the first and second meter-out valves and the first meter-in valve are closed and in which the second meter-in valve is opened, and calibrate the second pressure-calculation map such that the pressure calculated on the basis of the second pressure-calculation map matches the pressure calculated on the basis of the supply-pressure-calculation map.

2. The construction machine according to claim 1, further comprising:
a first-valve-position sensor that senses a valve position of the first meter-in valve; and
a second-valve-position sensor that senses a valve position of the second meter-in valve, wherein
the controller is configured to
calculate the valve position of the first meter-in valve from a sensing signal of the first-valve-position sensor on a basis of a first position-calculation map representing a characteristic of the first-valve-position sensor, and
calculate the valve position of the second meter-in valve from a sensing signal of the second-valve-position sensor on a basis of a second position-calculation map representing a characteristic of the second-valve-position sensor, and
the controller is configured to
actuate the first meter-in valve in a state in which the first and second meter-out valves and the second meter-in valve are closed, and calibrate the first position-calculation map such that the valve position calculated on the basis of the first position-calculation map when the first meter-in valve is at a minimum position becomes a minimum position, and the valve position calculated on the basis of the first position-calculation map when the first meter-in valve is at a maximum position becomes a maximum position, or
actuate the second meter-in valve in a state in which the first and second meter-out valves and the first meter-in valve are closed, and calibrate the second position-calculation map such that the valve position calculated on the basis of the second position-calculation map when the second meter-in valve is at a minimum position becomes a minimum position, and the valve position calculated on the basis of the second position-calculation map when the second meter-in valve is at a maximum position becomes a maximum position.

3. The construction machine according to claim 1, wherein
the controller is configured to
actuate the bleed-off valve in a state in which the first and second meter-out valves and the second meter-in valve are closed and in which the first meter-in valve is opened, and calibrate the first pressure-calculation map such that the pressure calculated on the basis of the first pressure-calculation map matches the pressure calculated on the basis of the supply-pressure-calculation map, or
actuate the bleed-off valve in a state in which the first and second meter-out valves and the first meter-in valve are closed and in which the second meter-in valve is opened, and calibrate the second pressure-calculation map such that the pressure calculated on the basis of the second pressure-calculation map matches the pressure calculated on the basis of the supply-pressure-calculation map.

4. The construction machine according to claim 1, wherein
the supply-pressure sensor is installed on a hydraulic line portion of a hydraulic line connecting the hydraulic pump and the first or second meter-in valve, the hydraulic line portion excluding a hydraulic line portion connecting the hydraulic pump and the bleed-off valve.
